(19) United States
(12) Patent Application Publication
(10) Pub. No.: US 2026/0359915 A1
(43) Pub. Date: Nov. 12, 2026

(54) WonderfulWorld Blueprint

(71) Applicant: Dakota Jayne Bruner, Detroit, MI (US)

(72) Inventor: Dakota Jayne Bruner, Detroit, MI (US)

(21) Appl. No.: 19/204,491

(22) Filed: May 10, 2025

(51) Int. Cl. G06Q 50/20; G06Q 50/40

(52) U.S. Cl. CPC G06Q 50/205; G06Q 50/40

(57) ABSTRACT

The WonderfulWorld Blueprint discloses a novel ecosystem designed to foster innovation and human capital development among youth. This ecosystem addresses the gap between traditional education and the technology-driven workplace, inequities in access to opportunity, and the need to cultivate a culture of innovation among youth. It comprises four interconnected pillars: the WonderfulWorld Foundation, which establishes after-school programs to provide students with access to technology, mentorship, and skill-building opportunities; WonderfulWorld Foundation, Advocacy, which leverages program data to advocate for policy changes and curriculum enhancements; WonderfulWorld Ventures, which incubates and supports student-led ventures; and WonderfulWorld Ventures, Consumer and Commerce, which facilitates the commercialization and distribution of student-developed products. This holistic approach aims to empower youth, promote innovation, and contribute to socioeconomic progress by putting human capital at the forefront of investment.

### INVENTOR AND INVENTION

I, Dakota Bruner, a citizen of the United States and a resident of Detroit, Michigan, am the inventor and sole applicant of the present invention, entitled “WonderfulWorld Blueprint.” This document discloses details for the purpose of obtaining a nonprovisional utility patent for the WonderfulWorld Blueprint, which comprises a novel business methodology and structural design for an ecosystem aimed at fostering innovation and human capital development among youth, particularly within the fields of technology, entrepreneurship, and commerce.

### BACKGROUND OF THE INVENTION

### Field of the Invention

The present invention relates generally to the field of human capital investment, and more specifically to an ecosystem designed to foster innovation and human capital development among youth.

### Description of the Invention

Human capital encompasses the knowledge, skills, and abilities of individuals and organizations, representing valuable assets that contribute to economic growth and societal progress. However, there exists a growing disparity between the skills and knowledge imparted by traditional education systems and the rapidly evolving demands of a technology-driven workplace. This disparity, coupled with inequities in access to opportunity and a need to further foster innovation and creativity within educational settings, presents significant challenges for youth development and future workforce preparedness.

Furthermore, many students face challenging circumstances or environments at home that can negatively impact their mental health, emotional well-being, and overall development. These challenges underscore the need for comprehensive support systems that not only provide educational opportunities but also nurture the holistic growth of young individuals.

Having served as a Human Capital Partner within the high-growth technology sector and youth mentor, I recognized these critical challenges and developed the WonderfulWorld Blueprint as a novel solution. This invention introduces a unique ecosystem designed to bridge the gap between education and the workplace, foster a culture of innovation, and provide comprehensive support for youth, empowering them to thrive in a technology-driven world.

The WonderfulWorld Blueprint offers a proactive approach to human capital investment, creating a unified framework for cultivating the next generation of innovators, entrepreneurs, and leaders. By replicating this methodology across the United States and the world, I envision a multi-dimensional socioeconomic impact, transforming youth development and shaping a brighter future for generations to come.

### SUMMARY

The “WonderfulWorld Blueprint” describes a novel ecosystem designed to address several critical challenges facing youth today:
1. The growing gap between traditional education and the demands of a rapidly evolving technology-driven workplace: This gap results in a lack of preparedness among youth for the skills and knowledge required to thrive in technology-driven industries.
2. Inequities in access to opportunity: Students from underserved communities often lack access to the resources, mentorship, and opportunities necessary to develop their full potential and pursue careers in technology and innovation.
3. The need to foster a culture of innovation and creativity: Traditional education systems often prioritize standardized testing and rote memorization over creativity, critical thinking, and problem-solving skills, which are essential for success in the 21st-century economy.
4. The lack of adequate support and encouragement for students facing challenging circumstances: Many students experience difficult situations or environments at home that can negatively impact their mental health, emotional well-being, and overall development.

The WonderfulWorld ecosystem addresses these challenges by providing a comprehensive framework for human capital development among youth. It connects them with real-world mentors, fosters creativity, and provides opportunities for skill-building and entrepreneurial exploration within a supportive and encouraging environment. This approach aims to not only bridge the gap between education and the workplace but also to uplift students and combat mental health concerns by providing positive role models, fostering a sense of belonging, and empowering them to pursue their passions.

The blueprint outlines a four-pillar structure:
1. WonderfulWorld Foundation: Establishes after-school programs that provide students with access to technology, mentorship from professionals, and opportunities to develop and showcase innovative concepts through competitions.
2. WonderfulWorld Foundation, Advocacy: Leverages data and insights from the Foundation's programs to advocate for policy changes and curriculum enhancements within the education system.
3. WonderfulWorld Ventures: Incubates and supports the development of market-viable concepts generated by students within the Foundation's programs.
4. WonderfulWorld Ventures, Consumer and Commerce: Facilitates the commercialization and distribution of student-developed products through retail partnerships and targeted marketing campaigns.

By integrating these pillars, the WonderfulWorld Blueprint aims to create a sustainable system that empowers youth, fosters innovation, and contributes to socioeconomic progress by putting human capital at the heart of investment. This holistic approach addresses the root causes of the identified challenges, providing youth with the resources and opportunities they need to thrive in a technology-driven world while also nurturing their overall well-being.

### BRIEF DESCRIPTIONS OF DRAWINGS

### Drawing 1: WonderfulWorld Blueprint Overview

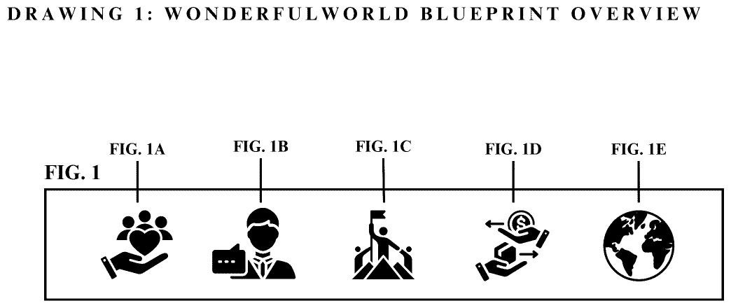

### FIG. 1: WonderfulWorld Blueprint; Overview of the 5-Phase Execution Plan

FIG. 1 represents the overall WonderfulWorld ecosystem, comprising four interconnected pillars: Foundation, Advocacy, Ventures, and Consumer and Commerce. Depicted as a black frame around secondary figures, FIG. 1 illustrates the phased development and integration of these pillars and the system's scalability to national and international levels.

### FIG. 1A: Phase One (1) of Ecosystem Structural Design, WonderfulWorld Foundation

FIG. 1A represents the WonderfulWorld Foundation pillar, illustrating the key steps involved in establishing and operating the foundation. These steps include securing funding, forming an advisory panel, launching the after-school program, holding competitions, and conducting annual progress evaluations. FIG. 1A, WonderfulWorld Foundation is depicted as an icon of a hand holding up/or uplifting a heart and three individuals.

### FIG. 1B: Phase Two (2), WonderfulWorld Foundation, Advocacy

FIG. 1B represents the WonderfulWorld Foundation, Advocacy pillar, illustrating the processes of collecting and analyzing student performance data, generating summarized reports, conducting advocacy efforts, performing annual progress evaluations, and maintaining a preservation and archive system. FIG. 1B, WonderfulWorld Foundation, Advocacy is depicted as an icon of a person speaking.

### FIG. 1C: Phase Three (3), WonderfulWorld Ventures

FIG. 1C represents the WonderfulWorld Ventures pillar, outlining the key aspects of establishing and operating a venture capital fund. This includes securing investors, forming a board of directors, assembling a team, incubating winning concepts, preparing ventures for market entry, and ensuring they are ready for commercialization. FIG. 1C, WonderfulWorld Ventures is depicted as an icon of a person reaching the top of a summit or conquest with two supporters nearby.

### FIG. 1D: Phase Four (4), WonderfulWorld Ventures, Consumer and Commerce

FIG. 1D represents the WonderfulWorld Ventures, Consumer and Commerce pillar, focusing on the commercialization and distribution of products. This includes securing partnerships, ensuring product quality and compliance, developing go-to-market strategies, conducting pop-up campaigns, establishing a lifestyle media group, and implementing give-back programs. FIG. 1D, WonderfulWorld Ventures, Consumer and Commerce is depicted as an icon of two hands; one exchanging a shipping box, the other exchanging money.

### FIG. 1E: Phase Five (5) WonderfulWorld at Scale

FIG. 1E illustrates the WonderfulWorld program at scale, showcasing its expansion to reach more students nationally and internationally. It highlights the program's role as an intelligence partner and its commitment to empowering young innovators. FIG. 1E, WonderfulWorld At Scale is depicted as a globe.

### Drawing 2: WonderfulWorld Foundation; Funding and Advisory

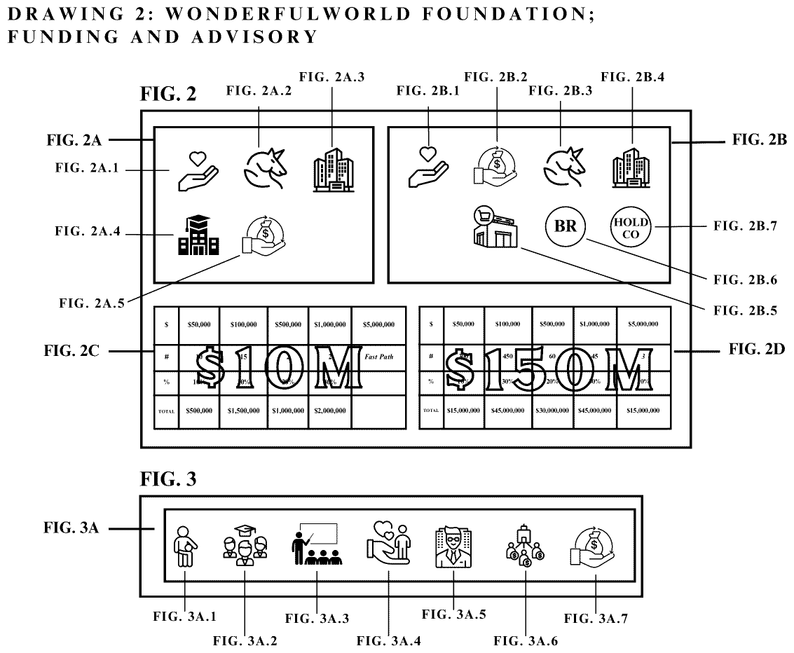

### FIG. 2: Secure Funding

Illustrated as a black frame, FIG. 2 represents the initial step in establishing the WonderfulWorld Foundation, focused on securing funding from various sources. The secondary figures within show the funding targets and potential funding partners.
FIG. 2A: FIG. 2A illustrates the sources of seed funding as a collective group, shown as a black frame enclosing the seed funding partner figures.
   FIG. 2A.1: Depicted as an icon of a hand holding up or uplifting a heart, FIG. 2A.1 represents Family Foundations as a source of seed funding.
   FIG. 2A.2: Depicted as an icon of a unicorn, FIG. 2A.2 represents Unicorns and Decacorns as a source of seed funding.
   FIG. 2A.3: Depicted as an icon of a multi-tower building, FIG. 2A.3 represents Big Tech Investment Funds and Companies with Philanthropic Investment Arms as a source of seed funding.
   FIG. 2A.4: Depicted as an icon of a building with a square graduation cap, FIG. 2A.4 represents University Advancement and Other Programs (Youth and R&D) as a source of seed funding.
   FIG. 2A.5: Depicted as an icon of an open hand holding out a bag with a dollar sign, FIG. 2A.5 represents Individual Investors as a source of seed funding.
FIG. 2B: Illustrated as a black frame, FIG. 2B shows the Stretch Goals Funding Partners as a collective group. Some of the Stretch Goal Funding Partners are first present in seed funding (FIG. 2A). Kindly note, for the purpose of the reading and/or creating from a blueprint, each funding partner/donor should be reviewed and understood within their respective placements as they serve at different stages and times.
   FIG. 2B.1: Depicted as an icon of a hand holding up or uplifting a heart, FIG. 2B.1 represents Family Foundations as Stretch Goals Funding Partners.
   FIG. 2B.2: Depicted as an icon of an open hand holding out a bag with a dollar sign, FIG. 2B.2 represents Individual Investors as Stretch Goals Funding Partners.
   FIG. 2B.3: Depicted as an icon of a unicorn, FIG. 2B.3 represents Unicorns and Decacorns as Stretch Goals Funding Partners.
   FIG. 2B.4: Depicted as an icon of a multi-tower building, FIG. 2B.4 represents Big Tech Investment Funds and Companies with Philanthropic Investment Arms as Stretch Goals Funding Partners.
   FIG. 2B.5: Depicted as an icon of a store or retailer with a shopping cart in a circle, FIG. 2B.5 represents Big Box Retailers as Stretch Goals Funding Partners.
   FIG. 2B.6: Depicted as a circle icon with the letters “BR” in the center, FIG. 2B.6 represents Brand Holding Companies as Stretch Goals Funding Partners.
   FIG. 2B.7: Depicted as a circular icon with the abbreviation “Hold Co”, FIG. 2B.7 represents Other Holding Companies as Stretch Goals Funding Partners.
FIG. 2C: FIG. 2C provides a visual representation of the $10,000,000 Seed

Goal in the form of an icon. While this figure is depicted as a table in the drawings, the specific numerical values within this table are not critical to the invention's scope and should be interpreted as a general representation of the seed funding goals and strategies. The key aspects of the seed funding strategy are the target funding amount and the identification of potential funding partners, which support the initial implementation of the WonderfulWorld Blueprint.
FIG. 2D: FIG. 2D provides a visual representation of the $150,000,000 Stretch Goal in the form of an icon. While this figure is depicted as a table in the drawings, the specific numerical values within this table are not critical to the invention's scope and should be interpreted as a general representation of the stretch funding goals and strategies. The key aspects of the stretch funding strategy are the target funding amount and the identification of potential funding partners, which support the scaling of the WonderfulWorld Blueprint.

### FIG. 3: Form Advisory Panel

Illustrated as a black frame around FIG. 3A and its secondary figures, FIG. 3 represents the formation of an advisory panel for the WonderfulWorld Foundation, composed of various stakeholders who provide guidance and support.
FIG. 3A: FIG. 3A is the Advisory Panel-A black frame around members of the panel represented as secondary figures.
   FIG. 3A.1: Depicted as an icon of an adult and child, FIG. 3A.1 represents Parents as Advisory Panel Members.
   FIG. 3A.2: Depicted as an icon of three individuals with a square graduation cap, FIG. 3A.2 represents Students as Advisory Panel Members.
   FIG. 3A.3: Depicted as an icon of an adult figure with a pointer in front of a board with three individuals, FIG. 3A.3 represents Teachers as Advisory Panel Members.
   FIG. 3A.4: Depicted as an icon of an open hand holding up or uplifting a person with two hearts, FIG. 3A.4 represents Foster Care Service Personnel as Advisory Panel Members.
   FIG. 3A.5: Depicted as an icon of a person with glasses and a tie in front of a building, FIG. 3A.5 represents Tech Founders/Tech Leadership as Advisory Panel Members.
   FIG. 3A.6: Depicted as an icon of three individuals each with a coin of money and a line connecting it to one central stack of squares, FIG. 3A.6 represents VC Leadership as Advisory Panel Members.
   FIG. 3A.7: Depicted as an icon of an open hand holding out a bag with a dollar sign on it, FIG. 3A.7 represents Individual Investors as Advisory Panel Members.

### Drawing 3: WonderfulWorld Foundation; Afterschool Program

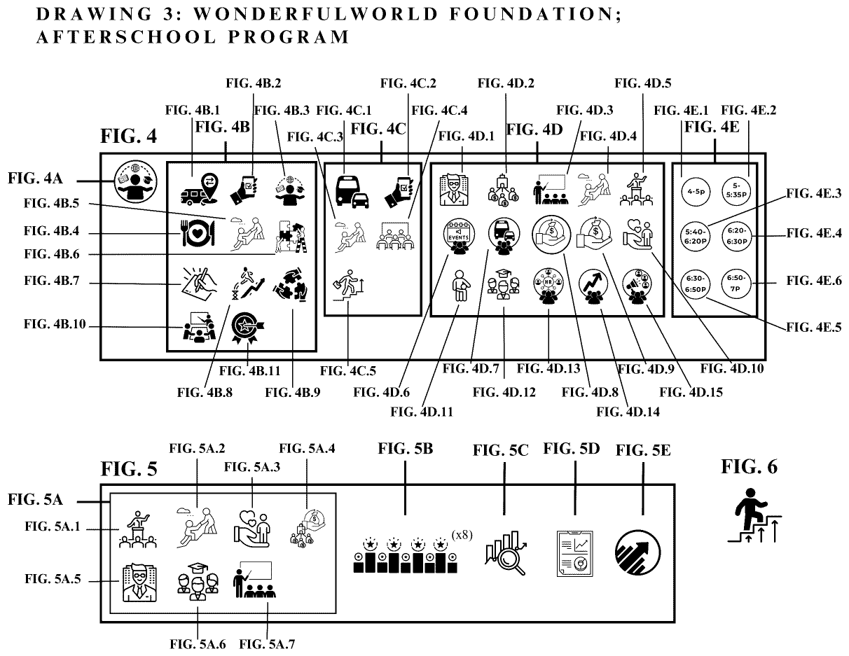

### FIG. 4: Launch Afterschool Program

Illustrated as a black frame around FIG. 4A and its secondary figures, FIG. 4 depicts the launch of the WonderfulWorld after-school program, highlighting key aspects such as transportation, parent communication, a structured learning environment, mentorship, and skill-building.
FIG. 4A: Depicted as an icon of a person in a circle with an open book, globe and graduation cap above them, FIG. 4A represents the Afterschool Program.
FIG. 4B: Illustrated as a black frame with secondary figures within, FIG. 4B represents an In-Depth View of the Afterschool Program by showing all involved components as a collective group.
   FIG. 4B.1: Depicted as an icon of a bus with a destination point, FIG. 4B.1 represents Shuttle Services as part of the Afterschool Program.
   FIG. 4B.2: Depicted as an icon of a hand holding a mobile device, FIG. 4B.2 represents the App for Parents as part of the Afterschool Program.
   FIG. 4B.3: Depicted as an icon of a person with an open textbook, globe, and graduation cap above them, FIG. 4B.3 represents Program Design for Learning Enjoyment as part of the Afterschool Program.
   FIG. 4B.4: Depicted as an icon of a round plate, fork and knife with a heart symbol in the center, FIG. 4B.4 represents Whole Food Balanced Meals as part of the Afterschool Program.
   FIG. 4B.5: Depicted as an icon of a person helping another step up on a rigid plane with a cloud in the background, FIG. 4B.5 represents Mentorship as part of the Afterschool Program.
   FIG. 4B.6: Depicted as an icon of two individuals putting puzzle pieces together, FIG. 4B.6 represents A Place to Explore, Learn, and Create as part of the Afterschool Program.
   FIG. 4B.7: Depicted as an icon of a hand writing on paper, FIG. 4B.7 represents Ideation of Concepts as part of the Afterschool Program.
   FIG. 4B.8: Depicted as an icon of a person leaping forward from a spring on an upward trajectory, FIG. 4B.8 represents Skill Building as part of the Afterschool Program.
   FIG. 4B.9: Depicted as an icon of three individuals putting three puzzle pieces together, FIG. 4B.9 represents Working Creatively in a Team Setting as part of the Afterschool Program.
   FIG. 4B.10: Depicted as an icon of one individual presenting at a board in front of three individuals at a table, FIG. 4B.10 represents Competitions for Presentation Skill Building as part of the Afterschool Program.
   FIG. 4B.11: Depicted as an icon of a ribbon with a star target and arrow in the center, FIG. 4B.11 represents Understanding of Concept Evaluation and Development as part of the Afterschool Program.
FIG. 4C: Illustrated as a black frame around secondary figures, FIG. 4C represents the After School Program Offerings as a collective view.
   FIG. 4C.1: Depicted as an icon of a bus and car, FIG. 4C.1 represents Transportation as an After School Program Offering.
   FIG. 4C.2: Depicted as an icon of a hand holding a mobile device, FIG. 4C.2 represents the Parent Communication App as an After School Program Offering.
   FIG. 4C.3: Depicted as an icon of a person helping another step up on a rigid plane with a cloud in the background, FIG. 4C.3 represents Mentorship by Working Professionals as an After School Program Offering.
   FIG. 4C.4: Depicted as an icon of five individuals in a classroom setting, FIG. 4C.4 represents an Expanded Classroom Setting as an After School Program Offering.
   FIG. 4C.5: Depicted as an icon of a person holding a briefcase on an upward trajectory (symbolized as a staircase and upward arrow), FIG. 4C.5 represents Skills for Career Acceleration as an After School Program Offering.
FIG. 4D: Illustrated as a black frame around secondary figures, FIG. 4D represents a collective view of the WonderfulWorld Foundation Volunteers and Staff.
   FIG. 4D.1: Depicted as an icon of a person with glasses and a tie in front of a building, FIG. 4D.1 represents Tech Leadership as WonderfulWorld Foundation Volunteers and Staff.
   FIG. 4D.2: Depicted as an icon of three individuals each with a coin of money and a line connecting it to one central stack of squares, FIG. 4D.2 represents Venture Capital Leadership as WonderfulWorld Foundation Volunteers and Staff.
   FIG. 4D.3: Depicted as an icon of an adult figure with a pointer in front of a board with three individuals, FIG. 4D.3 represents Teachers as WonderfulWorld Foundation Volunteers and Staff.
   FIG. 4D.4: Depicted as an icon of a person helping another step up on a rigid plane with a cloud in the background, FIG. 4D.4 represents Mentors as WonderfulWorld Foundation Volunteers and Staff.
   FIG. 4D.5: Depicted as an icon of a person at a podium in front of three individuals, FIG. 4D.5 represents Storytellers as WonderfulWorld Foundation Volunteers and Staff.
   FIG. 4D.6: Depicted as a circular icon with an events calendar in the center and three individuals below it, FIG. 4D.6 represents Event Planners and Operators as WonderfulWorld Foundation Volunteers and Staff.
   FIG. 4D.7: Depicted as a circular icon with the transportation icon and three individuals beneath it, FIG. 4D.7 represents Transportation Staff as WonderfulWorld Foundation Volunteers and Staff.
   FIG. 4D.8: Depicted as a circular icon with the investor icon in the center, FIG. 4D.8 represents Investor and Community Relations as WonderfulWorld Foundation Volunteers and Staff.
   FIG. 4D.9: Depicted as an icon of an open hand holding out a bag with a dollar sign, FIG. 4D.9 represents Individual Investors as WonderfulWorld Foundation Volunteers and Staff.
   FIG. 4D.10: Depicted as an icon of an open hand holding up or uplifting a person with two hearts, FIG. 4D.10 represents Foster Care Service Professionals as WonderfulWorld Foundation Volunteers and Staff.
   FIG. 4D.11: Depicted as an icon of an adult and child, FIG. 4D.11 represents Parents as WonderfulWorld Foundation Volunteers and Staff.
   FIG. 4D.12: Depicted as an icon of three individuals with a square graduation cap, FIG. 4D.12 represents Students as WonderfulWorld Foundation Volunteers and Staff.
   FIG. 4D.13: Depicted as a circular icon with a web chart with the letters ‘HR’ and with individuals beneath them, FIG. 4D.13 represents HR and Safety Leader as WonderfulWorld Foundation Volunteers and Staff.
   FIG. 4D.14: Depicted as a circular icon with an upward trajectory arrow and three individuals, FIG. 4D.14 represents the Business Development Team as WonderfulWorld Foundation Volunteers and Staff.
   FIG. 4D.15: Depicted as a circular icon with a megaphone connected by lines to three individuals, FIG. 4D.15 represents Communication and Branding as WonderfulWorld Foundation Volunteers and Staff.
FIG. 4E: Depicted as a black frame around secondary figures, FIG. 4E shows a Sample Schedule for the Afterschool Program.
   FIG. 4E.1: FIG. 4E.1 is shown as a circular icon representing the 4-5 PM window with activities including a well-balanced, whole-food meal and discussion related to current events in tech, commerce, and overall open discussion; ideas, school projects, etc.
   FIG. 4E.2: FIG. 4E.2 is a circular icon representing the 5-5:35 PM window where students participate in focused learning about a specific skill, technology, or world application.
   FIG. 4E.3: FIG. 4E.3 is a circular icon representing the 5:40-6:20 PM window where time is used to apply learning, skill application, or begin to build a concept.
   FIG. 4E.4: FIG. 4E.4 is a circular icon representing the 6:20-6:30 PM window, which is a Collective Break in the schedule.
   FIG. 4E.5: FIG. 4E.5 is a circular icon representing the 6:30-6: 50 PM window where Students and Mentors plan Next Steps and Action Items.
   FIG. 4E.6: FIG. 4E.6 is a circular icon representing the 6:50-7 PM window where students pack up, prepare to board the shuttle, get ready for pick up, or go to class if at school location, and in a morning setting.

### FIG. 5: Hold Competitions

Illustrated as a black frame around FIG. 5A-FIG. 5E, FIG. 5 illustrates the holding of competitions within the after-school program, providing opportunities to showcase skills and ideas.
FIG. 5A: Illustrated as a black frame around secondary figures, FIG. 5A shows the collective group of the WonderfulWorld Foundation Competition Volunteers.
   FIG. 5A.1: Depicted as an icon of a person at a podium in front of three individuals, FIG. 5A.1 represents Storytellers who unify both students and adults on mission and impact through storytelling as part of the WonderfulWorld Foundation Competition Volunteers.
   FIG. 5A.2: Depicted as an icon of a person helping another step up on a rigid plane with a cloud in the background, FIG. 5A.2 represents Mentors as part of the WonderfulWorld Foundation Competition Volunteers.
   FIG. 5A.3: Depicted as an icon of an open hand holding up or uplifting a person with two hearts, FIG. 5A.3 represents Foster Care Leaders as part of the WonderfulWorld Foundation Competition Volunteers.
   FIG. 5A.4: Depicted as the two icons; VC Leadership and Individual Investors, FIG. 5A.4 represents the Panel of Judges (VCs, Individual Investors) as part of the WonderfulWorld Foundation Competition Volunteers.
   FIG. 5A.5: Depicted as an icon of a person with glasses and a tie in front of a building, FIG. 5A.5 represents Tech Founders/Tech Leadership as part of the WonderfulWorld Foundation Competition Volunteers.
   FIG. 5A.6: Depicted as an icon of three individuals with a square graduation cap, FIG. 5A.6 represents Students as part of the WonderfulWorld Foundation Competition Volunteers.
   FIG. 5A.7: Depicted as an icon of an adult figure with a pointer in front of a board with three individuals, FIG. 5A.7 represents Teachers as part of the WonderfulWorld Foundation Competition Volunteers.
FIG. 5B: Depicted as eight vertical bars in two sizes with proportionate stars above, FIG. 5B represents the Competition Cadence.
FIG. 5C: Depicted as an icon of a bar chart displaying upward trajectory and a magnifying glass, FIG. 5C shows the process of Analyzing Winning Concepts for Market Fit.
FIG. 5D: Depicted as an icon of a report with charts on a clipboard, FIG. 5D represents the process of Compiling Valuation Reports.
FIG. 5E: Depicted as a circular icon with bar graphs and an arrow pointing toward an upward trajectory, FIG. 5E represents the process of Preparing to Incubate Winning Concepts in WonderfulWorld Ventures.

### FIG. 6: Annual Progress Evaluation

FIG. 6 represents the annual progress evaluation, assessing the program's impact on student development and concept generation. The figure is depicted as an icon of a person walking up a set of stairs with upward pointing arrows beneath each step.

### Drawing 4: WonderfulWorld Foundation, Advocacy

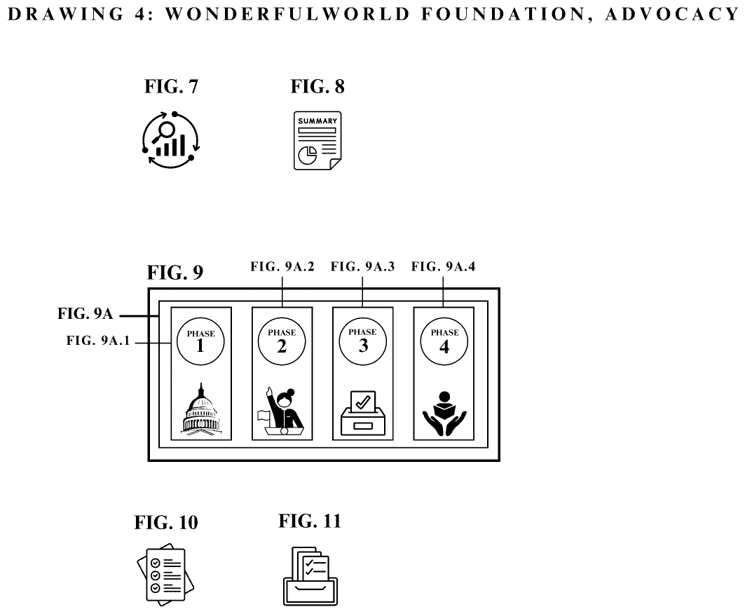

### FIG. 7: Data Collection & Analysis

FIG. 7 represents the data collection and analysis process within the Advocacy pillar. The figure is depicted as a circular icon with the border made of three arrows with end points, a scaling bar chart and a magnifying glass in the center.

### FIG. 8: Summarized Reporting

FIG. 8 represents the generation of summarized reports for advocacy initiatives. The figure is depicted as a rectangular icon with the word ‘summary’, lines and a graph.

### FIG. 9: Advocacy

FIG. 9 highlights advocacy efforts to influence educational policies. The figure is depicted as a black frame around FIG. 9A and its secondary figures.
FIG. 9A: Depicted as a black frame around secondary figures, FIG. 9A shows all phases of the Advocacy Workflow.
   FIG. 9A.1: Depicted as a rectangular icon with a circle and term “Phase 1” at the top and an icon of the US Capitol building at the bottom, FIG. 9A.1 represents Phase 1: Attend Legislative Branches as part of The Advocacy Workflow.
   FIG. 9A.2: Depicted as a rectangular icon with a circle and term “Phase 2” at the top and icon of a person at a podium with arm raised, FIG. 9A.2 represents Phase 2: Advocate for student curriculum enhancements using program performance data as part of The Advocacy Workflow.
   FIG. 9A.3: Depicted as a rectangular icon with a circle and term “Phase 3” at the top and an icon of a sheet of paper with a check mark entering a ballot box at the bottom, FIG. 9A.3 represents Phase 3: Government Officials vote changes into programs as part of The Advocacy Workflow.
   FIG. 9A.4: Depicted as a rectangular icon with a circle and term “Phase 4” at the top and an icon of open palms with a person reading a book at the bottom, FIG. 9A.4 represents Phase 4: End Result; Student curriculum is enhanced as part of The Advocacy Workflow.

### FIG. 10: Annual Progress Evaluation (Advocacy)

FIG. 10 represents the annual progress evaluation within the Advocacy pillar. The figure is depicted as an icon of a sheet of paper with three circled check marks and three sections of lines on top of another sheet of paper.

### FIG. 11: Preservation and Archives

FIG. 11 represents the preservation and archiving of data and reports. The figure is depicted as an icon of three sheets of paper being filed into a filing cabinet.

### Drawing 5: WonderfulWorld Ventures

### FIG. 12: Investors

FIG. 12 represents the investors involved in WonderfulWorld Ventures. It is depicted as a black frame around secondary figures.
FIG. 12A: Depicted as an icon of a hand holding up or uplifting a heart, FIG. 12A represents Family Foundations as Investors in WonderfulWorld Ventures.
FIG. 12B: Depicted as an icon of a unicorn, FIG. 12B represents Unicorns and

Decacorns as Investors in WonderfulWorld Ventures.
FIG. 12C: Depicted as an icon of a multi-tower building, FIG. 12C represents

Big Tech Investment Funds and Companies with Philanthropic Investment Arms as Investors in WonderfulWorld Ventures.
FIG. 12D: Depicted as an icon of a building with a square graduation cap, FIG. 12D represents University Advancement and Other Programs as Investors in WonderfulWorld Ventures.
FIG. 12E: Depicted as an icon of an open hand holding out a bag with a dollar sign, FIG. 12E represents Individual Investors as Investors in WonderfulWorld Ventures.
FIG. 12F: Depicted as an icon of a store or retailer with a shopping cart in a circle, FIG. 12F represents Big Box Retailers as Investors in WonderfulWorld Ventures.
FIG. 12G: Depicted as a circular icon with the letters “BR” in the center, FIG. 12G represents Brand Holding Companies as Investors in WonderfulWorld Ventures.
FIG. 12H: Depicted as a circular icon with the abbreviation “Hold Co”, FIG. 12H represents Other Holding Companies as Investors in WonderfulWorld Ventures.

### FIG. 13: Form Board of Directors

FIG. 13 represents the formation of a board of directors for WonderfulWorld Ventures. The figure is depicted as an icon of three individuals in seats.

### FIG. 14: Create Small Team

FIG. 14 represents the creation of a team to develop winning concepts. The figure is depicted as an icon of seven individuals in a group.

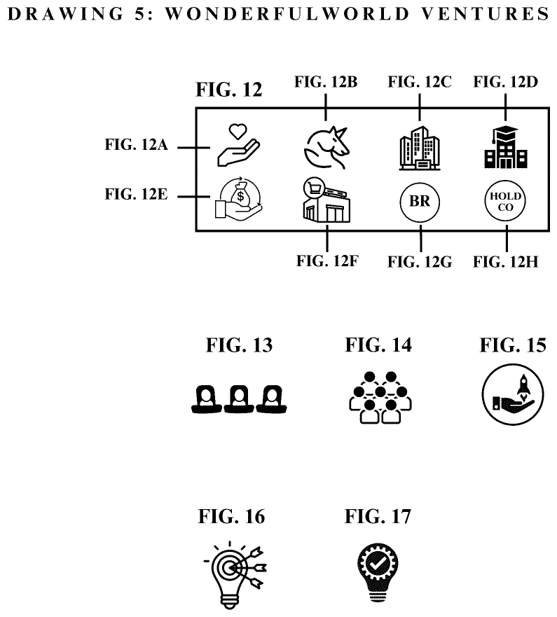

### FIG. 15: Incubate Winning Concepts as Projects

FIG. 15 represents the incubation process for winning concepts. The figure is depicted as a circular icon with a hand holding up or uplifting a rocket ship.

### FIG. 16: Prepare for Go-to-Market

FIG. 16 represents the preparation of ventures for market entry. The figure is depicted as an icon of a lightbulb with three darts in the center.

### FIG. 17: Go-to-Market Ready

FIG. 17 represents the final stage of preparation for market launch. The figure is depicted as an icon of an opaque lightbulb with a gear and checkmark in the center.

### Drawing 6: WonderfulWorld Ventures, Consumer and Commerce

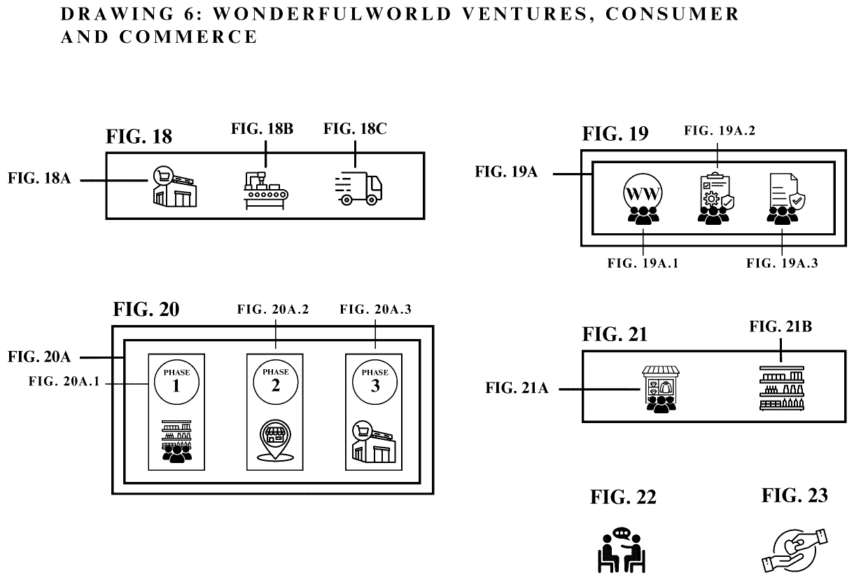

### FIG. 18: Secure Retailer and Go-to-Market Partnerships

FIG. 18 represents the process of securing partnerships for commercialization. The figure is depicted as a black frame around secondary figures.
FIG. 18A: Depicted as an icon of a store or retailer with a shopping cart in a circle, FIG. 18A represents Big Box Retailer Partnerships as part of securing partnerships for commercialization.
FIG. 18B: Depicted as an icon of a set of machinery equipment, FIG. 18B represents Product Manufacturing Partners as part of securing partnerships for commercialization.
FIG. 18C: Depicted as an icon of a box or semi truck moving forward, FIG. 18C represents Distribution Partners (Logistics) as part of securing partnerships for commercialization.

### FIG. 19: Quality and Compliance

FIG. 19 illustrates quality and compliance measures. FIG. 19 is depicted as a black frame surrounding FIG. 19A and its secondary figures.
FIG. 19A: Illustrated as a black frame around secondary figures, FIG. 19A represents the Teams and Partners Involved in quality and compliance measures.
   FIG. 19A.1: Depicted as a circular icon with the letters “WW” with three individuals beneath it, FIG. 19A.1 represents the Logo Certification Team as part of the Teams and Partners Involved in quality and compliance measures.
   FIG. 19A.2: Depicted as an icon of a clipboard with a checkmark, lines and gear with three individuals beneath it, FIG. 19A.2 represents the Quality Control Team as part of the Teams and Partners Involved in quality and compliance measures.
   FIG. 19A.3: Depicted as a sheet of paper with lines and a badge with a checkmark with three individuals beneath it, FIG. 19A.3 represents Product Regulation and Compliance Partners as part of the Teams and Partners Involved in quality and compliance measures.

### FIG. 20: Develop Go-To-Market Strategy/Campaign

FIG. 20 represents the development of go-to-market strategies. The figure is depicted as a black frame around FIG. 20A and its secondary figures.
FIG. 20A: Illustrated as a black frame around secondary figures, FIG. 20A represents the collective view of the Go-To-Market Workflow.
   FIG. 20A.1: Depicted as a rectangular icon with a circle with the term “Phase 1” at the top and an icon of store shelves and three individuals at the bottom, FIG. 20A.1 represents Phase One of the Go-To-Market Workflow which is to Form the GTM Strategy Team.
   FIG. 20A.2: Depicted as a rectangular icon with a circle at the top with the term “Phase 2” in the center and a geographic point with an icon of a store in the center bottom, FIG. 20A.2 represents Building Geo-Based GTM Strategies; Develop GTM Strategy; Specific to geographic location; street ‘pop-up’ and/or in retailer(s) as part of the Go-To-Market Workflow.
   FIG. 20A.3: Depicted as a rectangular icon with a circle at the top with the term “Phase 3” in the center and an icon of a store or retailer with a shopping cart in a circle, FIG. 20A.3 represents Engaging with Big Box Retailer Partnerships with campaigns specific to location. For example, collaboration or support with street ‘pop-up’ campaigns or in-store displays as part of the Go-To-Market Workflow.

### FIG. 21: Pop up Campaigns

FIG. 21 illustrates the execution of pop-up campaigns. The figure is depicted as a black frame around secondary figures.
FIG. 21A: Depicted as an icon of storefront and three individuals at the bottom, FIG. 21A represents the Pop Up Design+Execution Team as part of the execution of pop-up campaigns.
FIG. 21B: Depicted as an icon of store shelves, FIG. 21B represents Pop-Up; Shelf Display as part of the execution of pop-up campaigns.

### FIG. 22: Lifestyle Media Group

FIG. 22 represents the creation of a lifestyle media group for awareness. The figure is depicted as two seated individuals, one with a talking bubble.

### FIG. 23: Give Back Program(s)

FIG. 23 represents the implementation of give-back programs. The figure is depicted as an icon of one hand giving a figurative heart to an open hand beneath it with a circle behind both hands.

### Drawing 7: WonderfulWorld At Scale

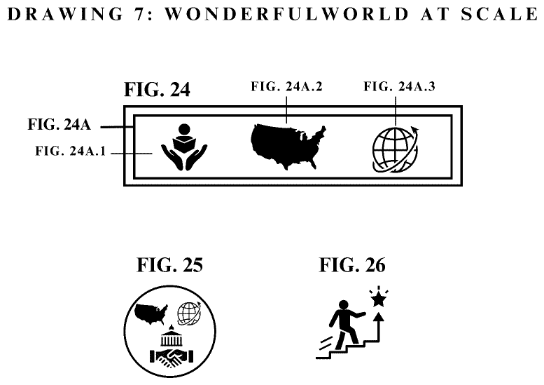

### FIG. 24: Expand WonderfulWorld Program

FIG. 24 depicts the expansion of the program nationally and internationally. The figure is depicted as a black frame around FIG. 24A and its secondary figures.
FIG. 24A: Illustrated as a black frame with secondary figures within, FIG. 24A represents the collective process of Globalizing Youth Curriculum, Insights, and Performance Preparedness as part of expanding the WonderfulWorld Program.
   FIG. 24A.1: Depicted as an icon of palms open and a person reading a book, FIG. 24A.1 represents Curriculum Enhancement as part of Globalizing Youth Curriculum, Insights, and Performance Preparedness.
   FIG. 24A.2: Depicted as an icon of the United States, FIG. 24A.2 represents successful deployment of the program in the United States of America as part of Globalizing Youth Curriculum, Insights, and Performance Readiness.
   FIG. 24A.3: Depicted as an icon of a globe with an arrow wrapping over it in an upward direction, FIG. 24A.3 represents the global reach and presence of the program as part of Globalizing Youth Curriculum, Insights, and Performance Readiness.

### FIG. 25: WonderfulWorld Positioned for Intelligence

FIG. 25 represents WonderfulWorld's position as an intelligence partner. The figure is depicted as a circular icon with two hands shaking, the United States of America icon, and the globe icon.

### FIG. 26: Empower Tomorrow's Innovators, Today

FIG. 26 represents the commitment to empowering young innovators. The figure is depicted as an individual moving swiftly up a staircase with an arrow and star at the top.

### DETAILED DESCRIPTION OF THE WONDERFULWORLD BLUEPRINT

### WonderfulWorld Blueprint Overview (Drawing 1, FIG. 1)

The WonderfulWorld Blueprint, as illustrated in Drawing 1, FIG. 1, introduces a novel ecosystem designed to address critical challenges facing youth today, namely the growing gap between traditional education and the demands of a rapidly evolving technology-driven workplace, inequities in access to opportunity, the need to foster a culture of innovation and creativity, and the lack of adequate support and encouragement for students facing challenging circumstances. This ecosystem provides a comprehensive framework for human capital development among youth, connecting them with real-world mentors, fostering creativity, and providing opportunities for skill-building and entrepreneurial exploration within a supportive and encouraging environment. This approach aims to not only bridge the gap between education and the workplace but also to uplift students and combat mental health concerns by providing positive role models, fostering a sense of belonging, and empowering them to pursue their passions.

The WonderfulWorld Blueprint is structured around four interconnected pillars: the WonderfulWorld Foundation (FIG. 1A, Drawings 2 and 3), WonderfulWorld Foundation, Advocacy (FIG. 1B, Drawing 4), WonderfulWorld Ventures (FIG. 1C, Drawing 5), and WonderfulWorld Ventures, Consumer and Commerce (FIG. 1D, Drawing 6). These pillars work together to create a sustainable system that empowers youth, fosters innovation, and contributes to socioeconomic progress by putting human capital at the heart or core of investment. FIG. 1E depicts WonderfulWorld's intention to scale to an international program, WonderfulWorld at Scale (FIG. 1E, Drawing 7).

### FIG. 1: WonderfulWorld Blueprint; Overview of the 5-Phase Execution Plan

FIG. 1 represents the overall WonderfulWorld ecosystem and its four interconnected pillars: Foundation, Advocacy, Ventures, and Consumer and Commerce. It illustrates the phased development and integration of these pillars and the system's scalability to national and international levels.
FIG. 1A: Phase One (1) of Ecosystem Structural Design, WonderfulWorld Foundation
   FIG. 1A represents the WonderfulWorld Foundation pillar, including the key steps involved in establishing and operating the foundation. These steps are securing funding, forming an advisory panel, launching the after-school program, holding competitions, and conducting annual progress evaluations.
FIG. 1B: Phase Two (2), WonderfulWorld Foundation, Advocacy
   FIG. 1B represents the WonderfulWorld Foundation, Advocacy pillar, including the processes of collecting and analyzing student performance data, generating summarized reports, conducting advocacy efforts, performing annual progress evaluations, and maintaining a preservation and archive system.
FIG. 1C: Phase Three (3), WonderfulWorld Ventures
   FIG. 1C represents the WonderfulWorld Ventures pillar, including the key aspects of establishing and operating a venture capital fund. This includes securing investors, forming a board of directors, assembling a team, incubating winning concepts, preparing ventures for market entry, and ensuring they are ready for commercialization.
FIG. 1D: Phase Four (4), WonderfulWorld Ventures, Consumer and Commerce
   FIG. 1D represents the WonderfulWorld Ventures, Consumer and

Commerce pillar, focusing on the commercialization and distribution of products. This includes securing partnerships, ensuring product quality and compliance, developing go-to-market strategies, conducting pop-up campaigns, establishing a lifestyle media group to drive awareness, and implementing give-back programs.
FIG. 1E: Phase Five (5) WonderfulWorld at Scale
   FIG. 1E represents the WonderfulWorld program at scale, depicting its expansion to reach more students nationally and internationally, including the program's role as an intelligence partner and its commitment to empowering young innovators.

### WonderfulWorld Foundation (Drawings 2 and 3, and FIG. 1A)

The WonderfulWorld Foundation, as depicted in Drawings 2 and 3, and FIG. 1A, is the cornerstone of the WonderfulWorld ecosystem. It focuses on establishing and operating after-school programs that provide students with access to technology, mentorship from professionals, and opportunities to develop and showcase innovative concepts through competitions.

### FIG. 2: Secure Funding

FIG. 2 represents the initial step in establishing the WonderfulWorld Foundation, focusing on securing funding from various sources. The figures within illustrate its funding targets and potential funding partners. The initial funding goal, or seed funding, is $10,000,000. The five-year funding goal is $50,000,000, and the stretch goal, if prior expectations are met, is $150,000,000. These funds will be used to create after-school programs in underserved communities, beginning with a pilot area and expanding to new areas over time. Potential funding sources include family foundations, unicorn and decacorn businesses, big tech investment funds, companies with philanthropic investment arms, university programs, and individual investors.
FIG. 2A: Shown as a black frame enclosing secondary figures, FIG. 2A illustrates the sources of seed funding as a collective group.
   FIG. 2A.1: Depicted as an icon of a hand holding up or uplifting a heart, FIG. 2A.1 represents Family Foundations as a source of seed funding.
   FIG. 2A.2: Depicted as an icon of a unicorn, FIG. 2A.2 represents Unicorns and Decacorns as a source of seed funding.
   FIG. 2A.3: Depicted as an icon of a multi-tower building, FIG. 2A.3 represents Big Tech Investment Funds and Companies with Philanthropic Investment Arms as a source of seed funding.
   FIG. 2A.4: Depicted as an icon of a building with a square graduation cap, FIG. 2A.4 represents University Advancement and Other Programs (Youth and R&D) as a source of seed funding.
   FIG. 2A.5: Depicted as an icon of an open hand holding out a bag with a dollar sign, FIG. 2A.5 represents Individual Investors as a source of seed funding.
FIG. 2B: FIG. 2B shows the Stretch Goals Funding Partners as a collective group. Some of the Stretch Goal Funding Partners are first present in seed funding (FIG. 2A). Kindly note, for the purpose of the reading and/or creating from a blueprint, each funding partner/donor should be reviewed and understood within their respective placements as they serve at different stages and times.
   FIG. 2B.1: Depicted as an icon of a hand holding up or uplifting a heart, FIG. 2B.1 represents Family Foundations as Stretch Goals Funding Partners.
   FIG. 2B.2: Depicted as an icon of an open hand holding out a bag with a dollar sign, FIG. 2B.2 represents Individual Investors as Stretch Goals Funding Partners.
   FIG. 2B.3: Depicted as an icon of a unicorn, FIG. 2B.3 represents Unicorns and Decacorns as Stretch Goals Funding Partners.
   FIG. 2B.4: Depicted as an icon of a multi-tower building, FIG. 2B.4 represents Big Tech Investment Funds and Companies with Philanthropic Investment Arms as Stretch Goals Funding Partners.
   FIG. 2B.5: Depicted as an icon of a store or retailer with a shopping cart in a circle, FIG. 2B.5 represents Big Box Retailers as Stretch Goals Funding Partners.
   FIG. 2B.6: Depicted as a circle icon with the letters “BR” in the center, FIG. 2B.6 represents Brand Holding Companies as Stretch Goals Funding Partners.
   FIG. 2B.7: Depicted as a circular icon with the abbreviation “Hold Co”, FIG. 2B.7 represents Other Holding Companies as Stretch Goals Funding Partners.
FIG. 2C: FIG. 2C provides a visual representation of the $10,000,000 Seed Goal in the form of an icon. While this figure is depicted as a table in the drawings, the specific numerical values within this table are not critical to the invention's scope and should be interpreted as a general representation of the seed funding goals and strategies. The key aspects of the seed funding strategy are the target funding amount and the identification of potential funding partners, which support the initial implementation of the WonderfulWorld Blueprint.
FIG. 2D: FIG. 2D provides a visual representation of the $150,000,000 Stretch Goal in the form of an icon. While this figure is depicted as a table in the drawings, the specific numerical values within this table are not critical to the invention's scope and should be interpreted as a general representation of the stretch funding goals and strategies. The key aspects of the stretch funding strategy are the target funding amount and the identification of potential funding partners, which support the scaling of the WonderfulWorld Blueprint.

### FIG. 3: Form Advisory Panel

Once funding is secured, an advisory panel is formed to guide the WonderfulWorld Foundation, as depicted in Drawing 2, and FIG. 1A. This panel comprises parents, students, teachers, foster care service personnel, technology leaders, venture capital leaders, and individual investors. These stakeholders provide voluntary guidance and support, leveraging their expertise to ensure the foundation's success.
   FIG. 3A: Shown as a black frame around secondary figures, FIG. 3A represents the Advisory Panel-Members shown as a collective group.
   FIG. 3A.1: Depicted as an icon of an adult and child, FIG. 3A.1 represents Parents as Advisory Panel Members.
   FIG. 3A.2: Depicted as an icon of three individuals with a square graduation cap, FIG. 3A.2 represents Students as Advisory Panel Members.
   FIG. 3A.3: Depicted as an icon of an adult figure with a pointer in front of a board with three individuals, FIG. 3A.3 represents Teachers as Advisory Panel Members.
   FIG. 3A.4: Depicted as an icon of an open hand holding up or uplifting a person with two hearts, FIG. 3A.4 represents Foster Care Service Personnel as Advisory Panel Members.
   FIG. 3A.5: Depicted as an icon of a person with glasses and a tie in front of a building, FIG. 3A.5 represents Tech Founders/Tech Leadership as Advisory Panel Members.
   FIG. 3A.6: Depicted as an icon of three individuals each with a coin of money and a line connecting it to one central stack of squares, FIG. 3A.6 represents VC Leadership as Advisory Panel Members.
   FIG. 3A.7: Depicted as an icon of an open hand holding out a bag with a dollar sign on it, FIG. 3A.7 represents Individual Investors as Advisory Panel Members.

### FIG. 4: After-School Program

With the advisory panel in place and funding secured, the WonderfulWorld Foundation launches its after-school program, as illustrated in Drawing 3, and FIG. 4A. This program serves as a space for youth to learn and advance their technological, business, and collaboration skills. It offers transportation services, ensuring students can safely attend the program. Parents have real-time access to their child's location, program topics, and daily recaps through a dedicated communication app. The after-school program provides a highly engaging classroom setting, designed to foster enjoyment of learning. It offers whole-food balanced meals, mentorship by working professionals, and opportunities for skill-building and concept development. The program operates on a weekly basis, typically from 4:00 PM to 7:00 PM local time, with the flexibility to adjust the schedule to meet the needs of the community, including potentially offering a before-school program.
FIG. 4A: Depicted as an icon of a person in a circle with an open book, globe and graduation cap above them, FIG. 4A represents the Afterschool Program.
FIG. 4B: FIG. 4B represents an In-Depth View of the Afterschool Program by showing all involved components as a collective group.
   FIG. 4B.1: Depicted as an icon of a bus with a destination point, FIG. 4B.1 represents Shuttle Services as part of the Afterschool Program.
   FIG. 4B.2: Depicted as an icon of a hand holding a mobile device, FIG. 4B.2 represents the App for Parents as part of the Afterschool Program.
   FIG. 4B.3: Depicted as an icon of a person with an open textbook, globe, and graduation cap above them, FIG. 4B.3 represents Program Design for Learning Enjoyment as part of the Afterschool Program.
   FIG. 4B.4: Depicted as an icon of a round plate, fork and knife with a heart symbol in the center, FIG. 4B.4 represents Whole Food Balanced Meals as part of the Afterschool Program.
   FIG. 4B.5: Depicted as an icon of a person helping another step up on a rigid plane with a cloud in the background, FIG. 4B.5 represents Mentorship as part of the Afterschool Program.
   FIG. 4B.6: Depicted as an icon of two individuals putting puzzle pieces together, FIG. 4B.6 represents A Place to Explore, Learn, and Create as part of the Afterschool Program.
   FIG. 4B.7: Depicted as an icon of a hand writing on paper, FIG. 4B.7 represents Ideation of Concepts as part of the Afterschool Program.
   FIG. 4B.8: Depicted as an icon of a person leaping forward from a spring on an upward trajectory, FIG. 4B.8 represents Skill Building as part of the Afterschool Program.
   FIG. 4B.9: Depicted as an icon of three individuals putting three puzzle pieces together, FIG. 4B.9 represents Working Creatively in a Team Setting as part of the Afterschool Program.
   FIG. 4B.10: Depicted as an icon of one individual presenting at a board in front of three individuals at a table, FIG. 4B.10 represents Competitions for Presentation Skill Building as part of the Afterschool Program.
   FIG. 4B.11: Depicted as an icon of a ribbon with a star target and arrow in the center, FIG. 4B.11 represents Understanding of Concept Evaluation and Development as part of the Afterschool Program.
FIG. 4C: FIG. 4C represents the After School Program Offerings as a collective view.
   FIG. 4C.1: Depicted as an icon of a bus and car, FIG. 4C.1 represents Transportation as an After School Program Offering.
   FIG. 4C.2: Depicted as an icon of a hand holding a mobile device, FIG. 4C.2 represents the Parent Communication App as an After School Program Offering.
   FIG. 4C.3: Depicted as an icon of a person helping another step up on a rigid plane with a cloud in the background, FIG. 4C.3 represents Mentorship by Working Professionals as an After School Program Offering.
   FIG. 4C.4: Depicted as an icon of five individuals in a classroom setting, FIG. 4C.4 represents an Expanded Classroom Setting as an After School Program Offering.
   FIG. 4C.5: Depicted as an icon of a person holding a briefcase on an upward trajectory (symbolized as a staircase and upward arrow), FIG. 4C.5 represents Skills for Career Acceleration as an After School Program Offering.
FIG. 4D: FIG. 4D represents a collective view of the WonderfulWorld Foundation Volunteers and Staff.
   FIG. 4D.1: Depicted as an icon of a person with glasses and a tie in front of a building, FIG. 4D.1 represents Tech Leadership as WonderfulWorld Foundation Volunteers and Staff.
   FIG. 4D.2: Depicted as an icon of three individuals each with a coin of money and a line connecting it to one central stack of squares, FIG. 4D.2 represents Venture Capital Leadership as WonderfulWorld Foundation Volunteers and Staff.
   FIG. 4D.3: Depicted as an icon of an adult figure with a pointer in front of a board with three individuals, FIG. 4D.3 represents Teachers as WonderfulWorld Foundation Volunteers and Staff.
   FIG. 4D.4: Depicted as an icon of a person helping another step up on a rigid plane with a cloud in the background, FIG. 4D.4 represents Mentors as WonderfulWorld Foundation Volunteers and Staff.
   FIG. 4D.5: Depicted as an icon of a person at a podium in front of three individuals, FIG. 4D.5 represents Storytellers as WonderfulWorld Foundation Volunteers and Staff.
   FIG. 4D.6: Depicted as a circular icon with an events calendar in the center and three individuals below it, FIG. 4D.6 represents Event Planners and Operators as WonderfulWorld Foundation Volunteers and Staff.
   FIG. 4D.7: Depicted as a circular icon with the transportation icon and three individuals beneath it, FIG. 4D.7 represents Transportation Staff as WonderfulWorld Foundation Volunteers and Staff.
   FIG. 4D.8: Depicted as a circular icon with the investor icon in the center, FIG. 4D.8 represents Investor and Community Relations as WonderfulWorld Foundation Volunteers and Staff.
   FIG. 4D.9: Depicted as an icon of an open hand holding out a bag with a dollar sign, FIG. 4D.9 represents Individual Investors as WonderfulWorld Foundation Volunteers and Staff.
   FIG. 4D.10: Depicted as an icon of an open hand holding up or uplifting a person with two hearts, FIG. 4D.10 represents Foster Care Service Professionals as WonderfulWorld Foundation Volunteers and Staff.
   FIG. 4D.11: Depicted as an icon of an adult and child, FIG. 4D.11 represents Parents as WonderfulWorld Foundation Volunteers and Staff.
   FIG. 4D.12: Depicted as an icon of three individuals with a square graduation cap, FIG. 4D.12 represents Students as WonderfulWorld Foundation Volunteers and Staff.
   FIG. 4D.13: Depicted as a circular icon with a web chart with the letters ‘HR’ and with individuals beneath them, FIG. 4D.13 represents HR and Safety Leader as WonderfulWorld Foundation Volunteers and Staff.
   FIG. 4D.14: Depicted as a circular icon with an upward trajectory arrow and three individuals, FIG. 4D.14 represents the Business Development Team as WonderfulWorld Foundation Volunteers and Staff.
   FIG. 4D.15: Depicted as a circular icon with a megaphone connected by lines to three individuals, FIG. 4D.15 represents Communication and Branding as WonderfulWorld Foundation Volunteers and Staff.
FIG. 4E: FIG. 4E shows a Sample Schedule for the Afterschool Program.
   FIG. 4E.1: FIG. 4E.1 is a circular icon representing the 4-5 PM window with activities including a well-balanced, whole-food meal and discussion related to current events in tech, commerce, and overall open discussion; ideas, school projects, etc.
   FIG. 4E.2: FIG. 4E.2 is a circular icon representing the 5-5:35 PM window where students participate in focused learning about a specific skill, technology, or world application.
   FIG. 4E.3: FIG. 4E.3 is a circular icon representing the 5:40-6:20 PM window where time is used to apply learning, skill application, or begin to build a concept.
   FIG. 4E.4: FIG. 4E.4 is a circular icon representing the 6:20-6:30 PM window, which is a Collective Break in the schedule.
   FIG. 4E.5: FIG. 4E.5 is a circular icon representing the 6:30-6:50 PM window where Students and Mentors plan Next Steps and Action Items.
   FIG. 4E.6: FIG. 4E.6 is a circular icon representing the 6:50-7 PM window where students pack up, prepare to board the shuttle, get ready for pick up, or go to class if at school location, and in a morning setting.

### FIG. 5: Hold Competitions

The WonderfulWorld after-school program culminates in competitions held every eight weeks, as depicted in Drawing 3, FIG. 5. These competitions provide students with opportunities to showcase the skills they have learned and present their innovative ideas for the world. Students work alongside volunteer tech and business professionals, partners, peers, mentors, teachers, and program investors to refine their ideas into minimum viable products (MVPs). These MVPs are then judged and scored, with awards given to the top three ideas and participation memorabilia for all.
FIG. 5A: Shown as a black frame around secondary figures, FIG. 5A shows the collective group of the WonderfulWorld Foundation Competition Volunteers.
   FIG. 5A.1: Depicted as an icon of a person at a podium in front of three individuals, FIG. 5A.1 represents Storytellers who unify both students and adults on mission and impact through storytelling as part of the WonderfulWorld Foundation Competition Volunteers.
   FIG. 5A.2: Depicted as an icon of a person helping another step up on a rigid plane with a cloud in the background, FIG. 5A.2 represents Mentors as part of the WonderfulWorld Foundation Competition Volunteers.
   FIG. 5A.3: Depicted as an icon of an open hand holding up or uplifting a person with two hearts, FIG. 5A.3 represents Foster Care Leaders as part of the WonderfulWorld Foundation Competition Volunteers.
   FIG. 5A.4: Depicted as the two icons; VC Leadership and Individual Investors, FIG. 5A.4 represents the Panel of Judges (VCs, Individual Investors) as part of the WonderfulWorld Foundation Competition Volunteers.
   FIG. 5A.5: Depicted as an icon of a person with glasses and a tie in front of a building, FIG. 5A.5 represents Tech Founders/Tech Leadership as part of the WonderfulWorld Foundation Competition Volunteers.
   FIG. 5A.6: Depicted as an icon of three individuals with a square graduation cap, FIG. 5A.6 represents Students as part of the WonderfulWorld Foundation Competition Volunteers.
   FIG. 5A.7: Depicted as an icon of an adult figure with a pointer in front of a board with three individuals, FIG. 5A.7 represents Teachers as part of the WonderfulWorld Foundation Competition Volunteers.
FIG. 5B: Depicted as eight vertical bars in two sizes with proportionate stars above, FIG. 5B represents the Competition Cadence.
FIG. 5C: Depicted as an icon of a bar chart displaying upward trajectory and a magnifying glass, FIG. 5C shows the process of Analyzing Winning Concepts for Market Fit.
FIG. 5D: Depicted as an icon of a report with charts on a clipboard, FIG. 5D represents the process of Compiling Valuation Reports.
FIG. 5E: Depicted as a circular icon with bar graphs and an arrow pointing toward an upward trajectory, FIG. 5E represents the process of Preparing to Incubate Winning Concepts in WonderfulWorld Ventures.

### FIG. 6: Annual Progress Evaluation

The WonderfulWorld Foundation conducts an annual progress evaluation to assess the program's impact and effectiveness, as illustrated in Drawing 3, FIG. 6. The figure is depicted as an icon of a person walking up a set of stairs with upward pointing arrows beneath each step. The evaluation considers various metrics, including positive growth or positive change in child development, enjoyment for learning, skill development, discipline to actively participate, and positive perceptions of themselves, their future, and their mentors. The evaluation also takes into account the number of viable concepts generated, their market potential, and the overall progress made on concepts founded by the after-school program and competition.

### WonderfulWorld Foundation, Advocacy (Drawing 4, and FIG. 1B)

The WonderfulWorld Foundation, Advocacy pillar, as depicted in Drawing 4 and FIG. 1B, focuses on leveraging data and insights from the foundation's programs to advocate for policy changes and curriculum enhancements within the education system.

### FIG. 7: Data Collection & Analysis

The Advocacy pillar begins with data collection and analysis, as illustrated in Drawing 4, FIG. 7—Depicted as a circular icon with the border made of three arrows with end points, a scaling bar chart and a magnifying glass in the center. Data is collected from the WonderfulWorld Foundation's after-school program and competitions. This data is analyzed to generate statistics and is categorized for summarized reporting.

### FIG. 8: Summarized Reporting

Summarized reports are created based on the analyzed data-Depicted as a rectangular icon with the word ‘summary’, lines and a graph, shown as Drawing 4, FIG. 8. These reports are tailored for specific advocacy initiatives, such as government awareness campaigns, school implementation materials, and assessing the overall outcomes of the WonderfulWorld program.

### FIG. 9: Advocacy

Advocates within the WonderfulWorld Foundation, Advocacy pillar utilize the performance data from the after-school program and competitions to advise government branches and promote policy changes for student curriculum, as illustrated in Drawing 4, FIG. 9.
FIG. 9A: FIG. 9A shows all phases of the Advocacy Workflow.
   FIG. 9A.1: Depicted as a rectangular icon with a circle and term “Phase 1” at the top and an icon of the US Capitol building at the bottom, FIG. 9A.1 represents Phase 1: Attend Legislative Branches as part of The Advocacy Workflow.
   FIG. 9A.2: Depicted as a rectangular icon with a circle and term “Phase 2” at the top and icon of a person at a podium with arm raised, FIG. 9A.2 represents Phase 2: Advocate for student curriculum enhancements using program performance data as part of The Advocacy Workflow.
   FIG. 9A.3: Depicted as a rectangular icon with a circle and term “Phase 3” at the top and an icon of a sheet of paper with a check mark entering a ballot box at the bottom, FIG. 9A.3 represents Phase 3: Government Officials vote changes into programs as part of The Advocacy Workflow.
   FIG. 9A.4: Depicted as a rectangular icon with a circle and term “Phase 4” at the top and an icon of open palms with a person reading a book at the bottom, FIG. 9A.4 represents Phase 4: End Result; Student curriculum is enhanced as part of The Advocacy Workflow.

### FIG. 10: Annual Progress Evaluation (Advocacy)

The Advocacy pillar conducts an annual progress evaluation to measure the impact of its advocacy efforts, as depicted in Drawing 4, FIG. 10-S hown as an icon of a sheet of paper with three circled check marks and three sections of lines on top of another sheet of paper. Progress is assessed by the impact on educational policies and student outcomes across different geographic locations and year-over-year improvements.

### FIG. 11: Preservation and Archives

The Advocacy pillar maintains a preservation and archive system to store data, reports, advocacy efforts, and impact assessments, as illustrated in Drawing 4, FIG. 11—Shown as an icon of three sheets of paper being filed into a filing cabinet. This system ensures the long-term preservation of these records for continuous improvement, program scaling, and historical documentation.

### WonderfulWorld Ventures (Drawing 5, FIG. 1C)

WonderfulWorld Ventures, as depicted in Drawing 5 and FIG. 1C, is the venture capital arm of the WonderfulWorld ecosystem. It focuses on incubating and supporting the development of market-viable concepts generated by students within the WonderfulWorld Foundation's programs.

### FIG. 12: Investors

FIG. 12 depicts the collective view of the various investors involved in WonderfulWorld Ventures.
FIG. 12A: Depicted as an icon of a hand holding up or uplifting a heart, FIG. 12A represents Family Foundations as Investors in WonderfulWorld Ventures.
FIG. 12B: Depicted as an icon of a unicorn, FIG. 12B represents Unicorns and Decacorns as Investors in WonderfulWorld Ventures.
FIG. 12C: Depicted as an icon of a multi-tower building, FIG. 12C represents Big Tech Investment Funds and Companies with Philanthropic Investment Arms as Investors in WonderfulWorld Ventures.
FIG. 12D: Depicted as an icon of a building with a square graduation cap, FIG. 12D represents University Advancement and Other Programs as Investors in WonderfulWorld Ventures.
FIG. 12E: Depicted as an icon of an open hand holding out a bag with a dollar sign, FIG. 12E represents Individual Investors as Investors in WonderfulWorld Ventures.
FIG. 12F: Depicted as an icon of a store or retailer with a shopping cart in a circle, FIG. 12F represents Big Box Retailers as Investors in WonderfulWorld Ventures.
FIG. 12G: Depicted as a circular icon with the letters “BR” in the center, FIG. 12G represents Brand Holding Companies as Investors in WonderfulWorld Ventures.
FIG. 12H: Depicted as a circular icon with the abbreviation “Hold Co”, FIG. 12H represents Other Holding Companies as Investors in WonderfulWorld Ventures.

### FIG. 13: Form Board of Directors

Once funding is secured, WonderfulWorld Ventures forms a board of directors, as depicted in Drawing 5, FIG. 13—Illustrated as an icon of three individuals in seats. This board provides guidance and oversight for the venture capital fund's investment strategies and operations.

### FIG. 14: Create Small Team

WonderfulWorld Ventures assembles a small, specialized team to develop winning concepts from the WonderfulWorld Foundation, as illustrated in Drawing 5, FIG. 14—Depicted as an icon of seven individuals in a group. This team focuses on building the internal and foundational structure of each venture, including legal, finance, human resources, press, business attraction, and administrative support.

### FIG. 15: Incubate Winning Concepts As Projects

The WonderfulWorld Ventures team, with guidance from the board of directors, incubates winning concepts from the WonderfulWorld Foundation, as depicted in Drawing 5, FIG. 15—Illustrated as a circular icon with a hand holding up or uplifting a rocket ship. This involves developing the internal and foundational structure of each concept and preparing it for commercialization.

### FIG. 16: Prepare for Go-To-Market

The Go-To-Market (GTM) team within WonderfulWorld Ventures works to prepare incubated concepts for market entry, as illustrated in Drawing 5, FIG. 16—Depicted as an icon of a lightbulb with three darts in the center. This includes determining packaging, product distribution strategies, and profit allocation models.

### FIG. 17: Go-to-Market Ready

Once ventures are prepared for market launch, the GTM team finalizes all necessary legal, financial, and packaging information, as depicted in Drawing 5, FIG. 17—Illustrated as an icon of an opaque lightbulb with a gear and checkmark in the center. This ensures that ventures are ready for the Consumer and Commerce team.

### WonderfulWorld Ventures, Consumer and Commerce (Drawing 6, and FIG. 1D)

WonderfulWorld Ventures, Consumer and Commerce, as depicted in Drawing 6 and FIG. 1D, focuses on the commercialization and distribution of products developed by student ventures incubated within WonderfulWorld Ventures.

### FIG. 18: Secure Retailer and Go-to-Market Partnerships

The Venture, GTM team and Venture, Consumer and Commerce team collaborate to secure partnerships with national retailers, identify distribution partners, and ensure all consumer quality standards and regulations are met before launching products to market, as illustrated in Drawing 6, FIG. 18. These partnerships include: Big Box Retailer Partnerships (FIG. 18A), Product Manufacturing Partners (FIG. 18B), and Distribution Partners (Logistics) (FIG. 18C).
FIG. 18A: Depicted as an icon of a store or retailer with a shopping cart in a circle, FIG. 18A represents Big Box Retailer Partnerships as part of securing partnerships for commercialization.
FIG. 18B: Depicted as an icon of a set of machinery equipment, FIG. 18B represents Product Manufacturing Partners as part of securing partnerships for commercialization.
FIG. 18C: Depicted as an icon of a box or semi truck moving forward, FIG. 18C represents Distribution Partners (Logistics) as part of securing partnerships for commercialization.

### FIG. 19: Quality and Compliance

WonderfulWorld Ventures, Consumer and Commerce maintains strict quality and compliance standards for all products, as depicted in Drawing 6, FIG. 19. This includes a logo certification program to ensure brand alignment with the WonderfulWorld ecosystem and mission. The Logo Certification Team (FIG. 19A.1) works with brands to meet these standards. Additionally, the Quality Control Team (FIG. 19A.2) ensures product quality and safety measures are in place for at-scale distribution. Product regulation and compliance partners (FIG. 19A.3) are engaged to ensure long-term adherence to industry standards.
FIG. 19A: FIG. 19A represents the Teams and Partners Involved in quality and compliance measures.
   FIG. 19A.1: Depicted as a circular icon with the letters “WW” with three individuals beneath it, FIG. 19A.1 represents the Logo Certification Team as part of the Teams and Partners Involved in quality and compliance measures.
   FIG. 19A.2: Depicted as an icon of a clipboard with a checkmark, lines and gear with three individuals beneath it, FIG. 19A.2 represents the Quality Control Team as part of the Teams and Partners Involved in quality and compliance measures.
   FIG. 19A.3: Depicted as a sheet of paper with lines and a badge with a checkmark with three individuals beneath it, FIG. 19A.3 represents Product Regulation and Compliance Partners as part of the Teams and Partners Involved in quality and compliance measures.

### FIG. 20: Develop Go-To-Market Strategy/Campaign

A Go-To-Market (GTM) team develops comprehensive strategies and campaigns for each product offering, as depicted in Drawing 6, FIG. 20. The GTM Team (FIG. 20A.1) identifies locations for local community and retailer pop-up shops and develops detailed plans for the Pop-Up Design and Execution Team (FIG. 21A) to implement. These plans include:
   Build Geo-Based GTM Strategies (FIG. 20A.2): Develop GTM strategies specific to geographic locations, including street pop-up campaigns and in-store displays within retail partners.
   Engage with Big Box Retailer Partnerships (FIG. 20A.3): Collaborate with big box retailers on campaigns specific to their locations, including support for street pop-up campaigns or in-store displays.
FIG. 20A: FIG. 20A represents the collective view of the Go-To-Market Workflow.
   FIG. 20A.1: Depicted as a rectangular icon with a circle with the term “Phase 1” at the top and an icon of store shelves and three individuals at the bottom, FIG. 20A.1 represents Phase One of the Go-To-Market Workflow which is to Form the GTM Strategy Team.
   FIG. 20A.2: Depicted as a rectangular icon with a circle at the top with the term “Phase 2” in the center and a geographic point with an icon of a store in the center bottom, FIG. 20A.2 represents Building Geo-Based GTM Strategies; Develop GTM Strategy; Specific to geographic location; street ‘pop-up’ and/or in retailer(s) as part of the Go-To-Market Workflow.
   FIG. 20A.3: Depicted as a rectangular icon with a circle at the top with the term “Phase 3” in the center and an icon of a store or retailer with a shopping cart in a circle, FIG. 20A.3 represents Engaging with Big Box Retailer Partnerships with campaigns specific to location. For example, collaboration or support with street ‘pop-up’ campaigns or in-store displays as part of the Go-To-Market Workflow.

### FIG. 21: Pop Up Campaigns

The Pop-Up Design and Execution Team executes pop-up campaigns as defined in the GTM strategy phase depicted in Drawing 6, FIG. 21. These campaigns utilize creative pop-up displays (FIG. 21B) to showcase and promote products to consumers.
FIG. 21A: Depicted as an icon of storefront and three individuals at the bottom, FIG. 21A represents the Pop Up Design+Execution Team as part of the execution of pop-up campaigns.
FIG. 21B: Depicted as an icon of store shelves, FIG. 21B represents Pop-Up; Shelf Display as part of the execution of pop-up campaigns.

### FIG. 22: Lifestyle Media Group

WonderfulWorld Ventures, Consumer and Commerce establishes an in-house lifestyle media group to create awareness campaigns and build brand identity for WonderfulWorld products, as depicted in Drawing 6, FIG. 22—Illustrated as two seated individuals, one with a talking bubble. This group focuses on storytelling, showcasing student success stories, and connecting consumers with the young inventors behind the products.

### FIG. 23: Give Back Program(s)

WonderfulWorld Ventures, Consumer and Commerce implements give-back programs to allocate a portion of the profits from product sales, as depicted in Drawing 6, FIG. 23. This is illustrated as an icon of one hand giving a figurative heart to an open hand beneath it with a circle behind both hands. These profits are distributed to students, the WonderfulWorld Foundation, and WonderfulWorld Ventures, ensuring a sustainable cycle of reinvestment and support for the ecosystem.

### WonderfulWorld at Scale (Drawing 7, and FIG. 1E)

### FIG. 24: Expand WonderfulWorld Program

WonderfulWorld extends its reach internationally, aiming to enhance child welfare, create equity, and cultivate the next generation of collaborative innovators worldwide.
FIG. 24A: FIG. 24A represents the collective process of Globalizing Youth Curriculum, Insights, and Performance Preparedness as part of expanding the WonderfulWorld Program.
   FIG. 24A.1: Depicted as an icon of palms open and a person reading a book, FIG. 24A.1 represents Curriculum Enhancement as part of Globalizing Youth Curriculum, Insights, and Performance Preparedness.
   FIG. 24A.2: Depicted as an icon of the United States, FIG. 24A.2 represents successful deployment of the program in the United States of America as part of Globalizing Youth Curriculum, Insights, and Performance Readiness.
   FIG. 24A.3: Depicted as an icon of a globe with an arrow wrapping over it in an upward direction, FIG. 24A.3 represents the global reach and presence of the program as part of Globalizing Youth Curriculum, Insights, and Performance Readiness.

### FIG. 25: WonderfulWorld Positioned for Intelligence

WonderfulWorld positions itself as a reliable intelligence partner for the United States government and the global community, as illustrated in Drawing 7, FIG. 25—Depicted as a circular icon with two hands shaking, the United States of America icon, and the globe icon. This involves providing insights and data on youth development, innovation, and educational trends to the United States government and global community to inform policy decisions and support initiatives aimed at empowering young people.

### FIG. 26: Empower Tomorrow's Innovators, Today

WonderfulWorld's final step of the blueprint is its overarching commitment is to empower the next generation of innovators, as symbolized in Drawing 7, FIG. 26—Depicted as an individual moving swiftly up a staircase with an arrow and star at the top. By providing youth with the tools, resources, and opportunities to thrive in a technology-driven world, WonderfulWorld aims to foster a brighter and more collaborative future for all.

This concludes the Detailed Description of the WonderfulWorld Blueprint. This description, along with the drawings and claims, provides a comprehensive disclosure of the invention, enabling someone skilled in the art to make and use the invention.

1. A system for fostering innovation and human capital development among youth, comprising:
(a). a foundation pillar comprising: an after-school program configured to provide students with access to technology and mentorship; means for conducting competitions to showcase student-developed concepts; and means for evaluating student progress and program effectiveness;
(b). an advocacy pillar comprising: means for collecting and analyzing data on student performance and program outcomes; means for generating reports based on the analyzed data;
and means for disseminating the reports to government entities to advocate for policy changes and curriculum enhancements;
(c). a ventures pillar comprising: means for incubating student-developed concepts; and means for developing and supporting the formation of ventures based on incubated concepts; and
(d). a commercialization pillar comprising: means for securing retail and distribution partnerships; means for developing and executing go-to-market strategies for ventures and products and driving awareness; and means for allocating profits to students, investors, and the foundation pillar.

2. The system of claim 1, wherein the after-school program further comprises providing students with access to:
(a). transportation services;
(b). whole-food balanced meals;
(c). and a secure communication app for parent-guardian interaction.
